(19) United States
(12) Patent Application Publication
(10) Pub. No.: US 2025/0392054 A1
(43) Pub. Date: Dec. 25, 2025

(54) ANTENNA STRUCTURE

(71) Applicant: EMPLUS TECHNOLOGIES, INC., Taipei (TW)

(72) Inventor: Shih Ying CHAO, Taipei (TW)

(21) Appl. No.: 18/938,441

(22) Filed: Nov. 6, 2024

(30) Foreign Application Priority Data
Jun. 21, 2024 (TW) 113123086

(51) Int. Cl. H01Q 19/10; H01Q 1/48

(52) U.S. Cl. CPC H01Q 19/108; H01Q 1/48

(57) ABSTRACT

An antenna structure is provided. The antenna structure includes: a ground plane, a radiator, one or more reflectors and one or more switch elements. The radiator is arranged and suspended above the ground plane. The one or more reflectors form an angle with the radiator relative to the ground plane and are arranged at a distance around the periphery of the radiator. The one or more switch elements are respectively arranged between the one or more reflectors and the ground plane to control the connection between the one or more reflectors and the ground plane, thereby changing the horizontal radiation pattern of the antenna structure. Wherein the radiator is a dipole antenna radiator.

### CROSS-REFERENCES TO RELATED APPLICATIONS

This application claims priority to Taiwan Patent Application No. 113123086 filed on Jun. 21, 2024, the entire contents of which are incorporated herein by reference.

### BACKGROUND OF THE INVENTION

### Field of the Invention

The present invention relates to an antenna structure. More specifically, the present invention relates to an antenna structure for controlling the radiation pattern by reflectors and switch elements.

### Descriptions of the Related Art

For a traditional wireless router with a built-in antenna, the antenna structure thereof is arranged inside the housing of the wireless router, so the pointing position of the antenna structure is fixed. Moreover, since there is no antenna device arranged outside the housing of the wireless router, users cannot arbitrarily change the pointing position of the antenna inside the housing of the wireless router, and thus the radiation pattern of radiation signals emitted by the antenna cannot be adjusted and controlled.

In some cases, users may install wireless routers on walls, ceilings, or any corners in a space according to different requirements in use. If the radiation pattern of radiation signals emitted by the antenna cannot be adjusted and controlled according to the installation position, then the distribution range of radiation signals emitted by the wireless router will be limited so that the quality of signal transmission and reception of networked devices is remarkably reduced. Accordingly, an urgent need exists in the art to solve the problem that the radiation pattern of the antenna with fixed pointing position cannot be changed arbitrarily.

In the past, monopole antennas have been selected as built-in antennas of network apparatuses. Variations of the radiation pattern, especially the vertical radiation pattern, which can be provided by monopole antennas, are limited in the design. Furthermore, monopole antennas need a larger space on the horizontal plane when the fixed pointing position thereof is limited. Traditionally, in order to achieve the distribution of signals at various angles, omnidirectional antennas are often selected to overcome the limitation of signal distribution range.

### SUMMARY OF THE INVENTION

In order to solve at least the above problems, the present invention provides an antenna structure. The antenna structure includes: a ground plane, a radiator, one or more reflectors and one or more switch elements. The radiator is arranged and suspended above the ground plane. The one or more reflectors form an angle with the radiator relative to the ground plane and are arranged at a distance around the periphery of the radiator. The one or more switch elements are respectively arranged between the one or more reflectors and the ground plane to control the connection between the one or more reflectors and the ground plane, thereby changing the radiation pattern of the antenna structure. The radiator is a dipole antenna radiator.

As mentioned above, according to the present invention, with the arrangement of the one or more reflectors disposed at a distance around the periphery of the radiator in the antenna structure and the one or more switches connected to control the one or more reflectors, the one or more reflectors can be grounded after being electrically connected through the control of the one or more switches, and a reflection effect will be generated when the one or more reflectors are grounded. Radiation signals will be reflected by the one or more grounded reflectors immediately after they are emitted by the radiator in the antenna structure. Since the one or more reflectors are arranged at an angle (i.e., with an inclined surface), the radiation signals can also be reflected vertically by the angle. Accordingly, the antenna structure of the present invention can arbitrarily control and adjust the radiation pattern emitted by the antenna structure according to the use requirements of users. Therefore, the present invention can effectively solve the above problems.

What described above are not intended to limit the present invention, but only generally describe the technical problems that can be solved by the present invention, the technical means that can be adopted by the present invention and the technical effects that can be achieved by the present invention so as to provide preliminary appreciation of the present invention by those of ordinary skill in the art. According to the attached drawings and the contents described in the following embodiments, those of ordinary skill in the art can further appreciate the details of various embodiments of the present invention.

### BRIEF DESCRIPTION OF THE DRAWINGS

FIG. 1 illustrates a schematic perspective view of an antenna structure according to some embodiments of the present invention.

FIG. 2 illustrates a cross-sectional view of an antenna structure according to another embodiment of the present invention.

FIG. 3 illustrates a top view of the antenna structure according to some embodiments of the present invention.

FIG. 4A is a diagram illustrating the horizontal radiation pattern when reflectors are not turned on according to the present invention.

FIG. 4B is a diagram illustrating the X axis vertical radiation pattern when the reflectors are not turned on according to the present invention.

FIG. 4C is a schematic perspective view illustrating the radiation pattern when the reflectors are not turned on according to the present invention.

FIG. 5A is a diagram illustrating the horizontal radiation pattern when one reflector is turned on according to the present invention.

FIG. 5B is a diagram illustrating the X axis vertical radiation pattern when one reflector is turned on according to the present invention.

FIG. 5C is a diagram illustrating the Y axis vertical radiation pattern when one reflector is turned on according to the present invention.

FIG. 5D is a schematic perspective view illustrating the radiation pattern when one reflector is turned on according to the present invention.

FIG. 6A is a diagram illustrating the horizontal radiation pattern when two reflectors are turned on according to the present invention.

FIG. 6B is a diagram illustrating the X axis vertical radiation pattern when two reflectors are turned on according to the present invention.

FIG. 6C is a diagram illustrating the Y axis vertical radiation pattern when two reflectors are turned on according to the present invention.

FIG. 6D is a schematic perspective view illustrating the radiation pattern when two reflectors are turned on according to the present invention.

FIG. 7A is a diagram illustrating the horizontal radiation pattern when two reflectors are turned on according to the present invention.

FIG. 7B is a diagram illustrating the X axis vertical radiation pattern when two reflectors are turned on according to the present invention.

FIG. 7C is a diagram illustrating the Y axis vertical radiation pattern when two reflectors are turned on according to the present invention.

FIG. 7D is a schematic perspective view illustrating the radiation pattern when two reflectors are turned on according to the present invention.

FIG. 8A is a diagram illustrating the horizontal radiation pattern when three reflectors are turned on according to the present invention.

FIG. 8B is a diagram illustrating the X axis vertical radiation pattern when three reflectors are turned on according to the present invention.

FIG. 8C is a diagram illustrating the Y axis vertical radiation pattern when three reflectors are turned on according to the present invention.

FIG. 8D is a schematic perspective view illustrating the radiation pattern when three reflectors are turned on according to the present invention.

FIG. 9A is a diagram illustrating the horizontal radiation pattern when four reflectors are turned on according to the present invention.

FIG. 9B is a diagram illustrating the X axis vertical radiation pattern when four reflectors are turned on according to the present invention.

FIG. 9C is a diagram illustrating the Y axis vertical radiation pattern when four reflectors are turned on according to the present invention.

FIG. 9D is a schematic perspective view illustrating the radiation pattern when four reflectors are turned on according to the present invention.

FIG. 10 illustrates a schematic perspective view of an antenna structure according to another embodiment of the present invention.

### DESCRIPTION OF THE PREFERRED EMBODIMENT

Hereinafter, the present invention will be described with reference to a number of embodiments. However, these embodiments are not intended to limit the present invention to be implemented only according to operations, environment, applications, structures, flow processes or steps described herein. Elements unrelated to the present invention are omitted from depiction, but may be implied in the attached drawings. In the attached drawings, dimensions of and dimensional scales among individual elements are provided only for illustration, and are not intended to limit the present invention. Unless otherwise specified, in the following description, the same (or similar) reference numerals may correspond to the same (or similar) elements. Unless otherwise specified, the number of respective elements described below may be one or more while being implementable.

Terms used in this disclosure are only for describing the embodiments and are not intended to limit the present invention. Unless clearly indicated otherwise in the context, the singular form “a/an/one” is intended to include the plural form as well. Terms such as “including” and “comprising” indicate the presence of features, integers, steps, operations, elements and/or components described herein, but do not exclude the presence of one or more other features, integers, steps, operations, elements, components and/or combinations thereof. The term “and/or” includes any and all combinations of one or more related items listed.

Unless indicated otherwise in the context, expressions such as “first” and “second” are only used for distinguishing the elements preceded by the expressions instead of indicating the sequence of the elements.

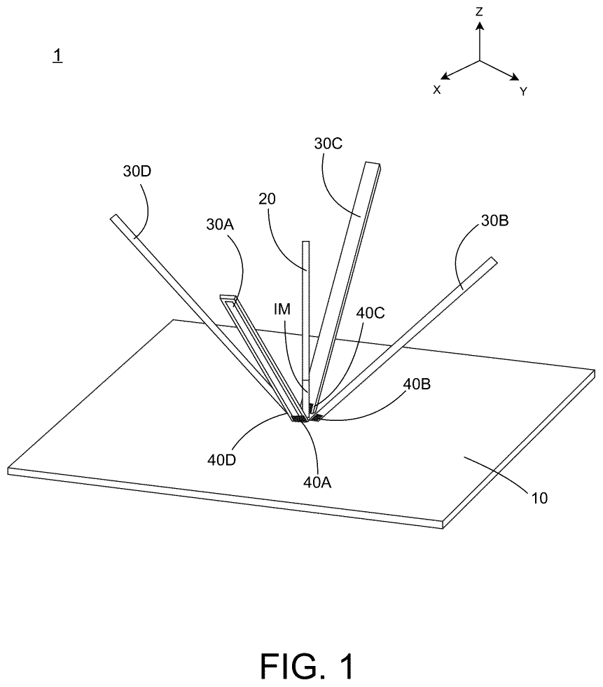

FIG. 1 illustrates a schematic perspective view of an antenna structure according to some embodiments of the present invention. The content shown in FIG. 1 is only for illustrating the embodiment of the present invention, and is not intended to limit the scope claimed in the present invention.

Referring to FIG. 1, an antenna structure 1 is provided in the present invention. The antenna structure 1 includes a ground plane 10, a radiator 20, one or more reflectors (such as, but not limited to, reflectors 30A, 30B, 30C and 30D) and one or more switch elements (such as, but not limited to, switch elements 40A, 40B, 40C and 40D). The radiator 20 is a dipole antenna radiator and is arranged and suspended above the ground plane 10. For example, a bracket or a supporting base made of insulating material IM (such as ceramics, glass, wood, polyethylene and polystyrene, etc.) may be arranged between the ground plane 10 and the radiator 20 to make the radiator 20 suspend above the ground plane 10.

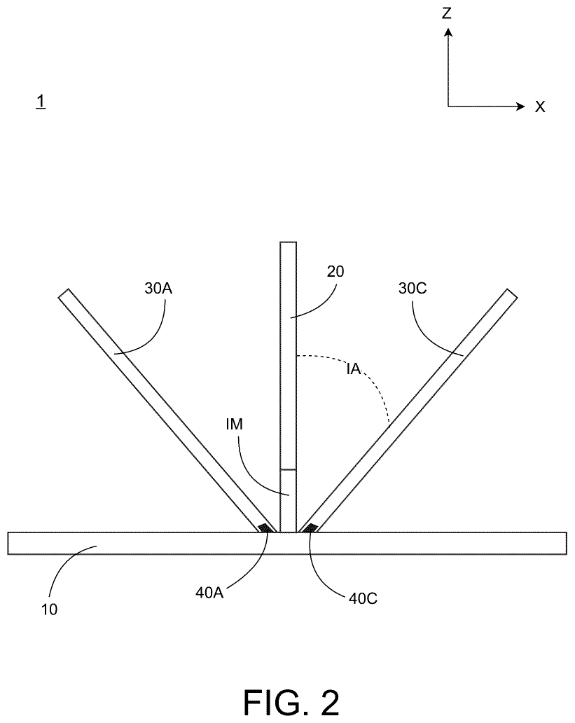

Referring to FIG. 2, FIG. 2 is a cross-sectional side view of the antenna structure 1 taken in the X axis direction, and thus only the reflector 30A and the reflector 30C are schematically depicted. Since the reflectors 30A, 30B, 30C and 30D form an angle IA with the radiator 20 relative to the ground plane 10 and are arranged at a distance around the periphery of the radiator 20, the distance between the reflectors and the radiator may range from 1 mm to 10 mm with the optimal distance therebetween of 5 mm. Moreover, the switch elements 40A, 40B, 40C and 40D are respectively arranged between the reflectors 30A, 30B, 30C and 30D and the ground plane 10 to control the connection between the reflectors 30A, 30B, 30C and 30D and the ground plane 10, thereby changing the radiation pattern of radiation signals emitted by the antenna structure 1 in the horizontal direction and the vertical direction. In addition, the angle IA may range from 30 to 60 degrees with a preferred angle of 45 degrees, the length of the radiator 20 may range from 0.45λ to 0.55λ (lambda) with a preferred length of 0.5λ, and the length of the reflectors 30A, 30B, 30C and 30D may range from 0.5λ to 0.62λ with a preferred length of 0.56λ. The reflectors 30A, 30B, 30C and 30D can achieve the best reflection effect in combination with such wavelength segment ratios.

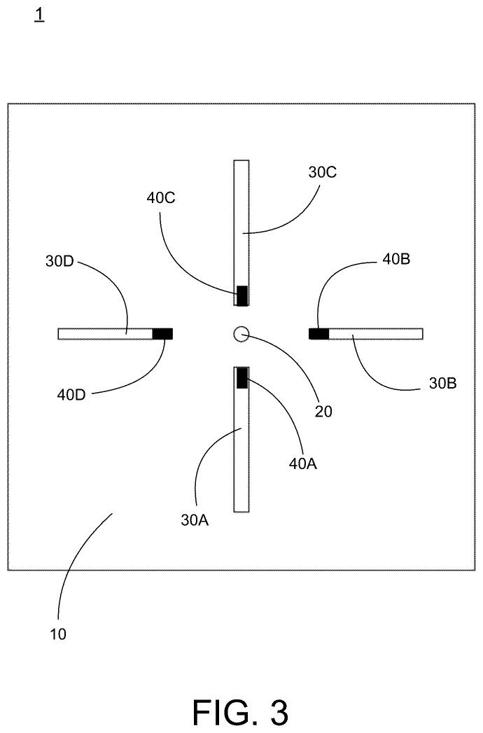

As shown in FIG. 3, the reflectors 30A, 30B, 30C and 30D are symmetrically and equidistantly arranged around the periphery of the radiator 20 with the radiator 20 as a center. Moreover, the reflectors 30A, 30B, 30C and 30D may be respectively arranged at positions of 0 degree, 90 degrees, 180 degrees and 270 degrees relative to the radiator 20. Accordingly, when the radiator 20 of the antenna structure 1 emits radiation signals, the radiation signals will be spread outward in the horizontal direction with the radiator 20 as a center due to the characteristics of the dipole antenna.

Specifically, in some embodiments, the reflectors 30A, 30B, 30C and 30D may be made of metals, but the materials of the reflectors 30A, 30B, 30C and 30D are not limited in the present invention. The reflectors 30A, 30B, 30C and 30D are preferably made of metals such as copper, silver and gold. The internal impedance of metal is so small so that the electrons therein can move freely. Therefore, when the metal (such as the reflector or the ground plane) is affected by an external electric field (such as electric radiation signals emitted by the radiator), electrons inside the metal will move under the action of the external electric field, thereby forming an induced current inside the metal. The induced current will generate an induced electric field whose direction is opposite to that of the external electric field, so the induced electric field and the external electric field will cancel each other out and a reflection effect will be generated. The distance range of electron movement is the distance range (length) of the induced current, thus the size of metal will affect the length of the induced current, and the length of the induced current will affect the frequency range of the reflective electric field. According to the electromagnetic theory, the frequency of the electric field is inversely proportional to the wavelength. That is, the higher the frequency of the electric field is, the shorter the wavelength and the shorter the induced current will be; and on the contrary, the lower the frequency of the electric field is, the longer the wavelength and the longer the induced current will be. In this case, the reflectors 30A, 30B, 30C and 30D are small-sized, and thus when the reflectors 30A, 30B, 30C and 30D are not electrically connected to the ground plane, an induced current of sufficient length cannot be generated, and therefore the radiation signals cannot be reflected.

In other words, when the reflectors 30A, 30B, 30C and 30D are in ungrounded state (that is, the switch elements 40A, 40B, 40C and 40D are not turned on), they have no influence on the radiation signals of the radiator 20. When the reflectors 30A, 30B, 30C and 30D are electrically connected via the switch elements 40A, 40B, 40C and 40D, the reflectors 30A, 30B, 30C and 30D will be grounded to the ground plane 10. Therefore, when the radiation signals are received, the reflectors will provide the reflection effect on the radiation signals (that is, the external electric field). Meanwhile, the reflection direction can also be controlled by the angle at which the reflectors are arranged, so as to provide a plurality of radiation pattern modes.

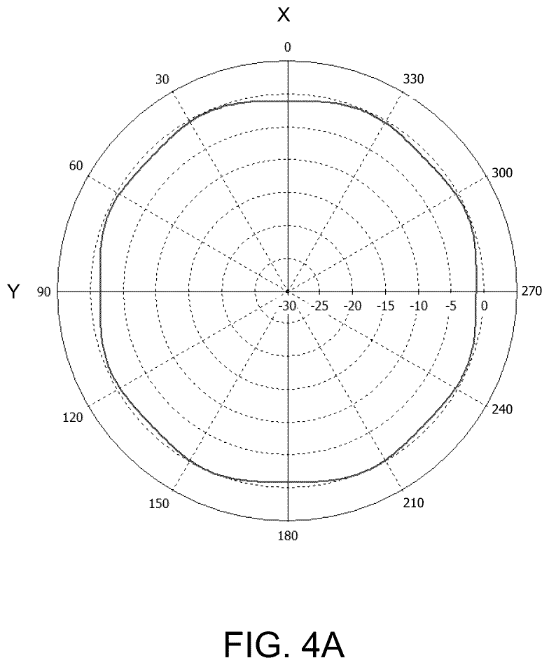

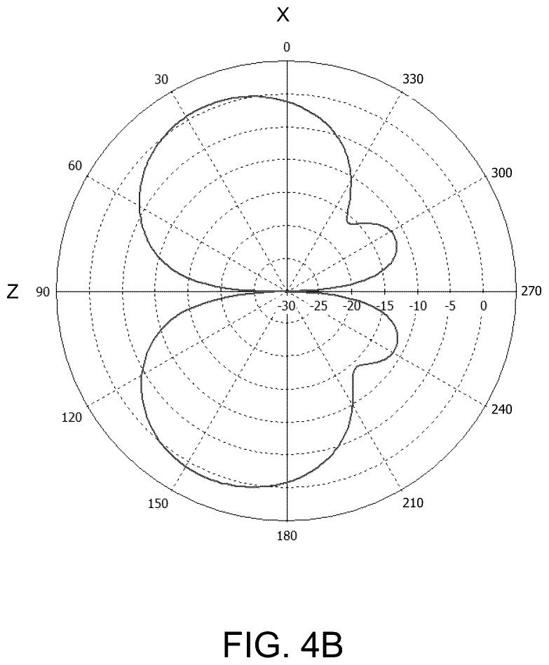

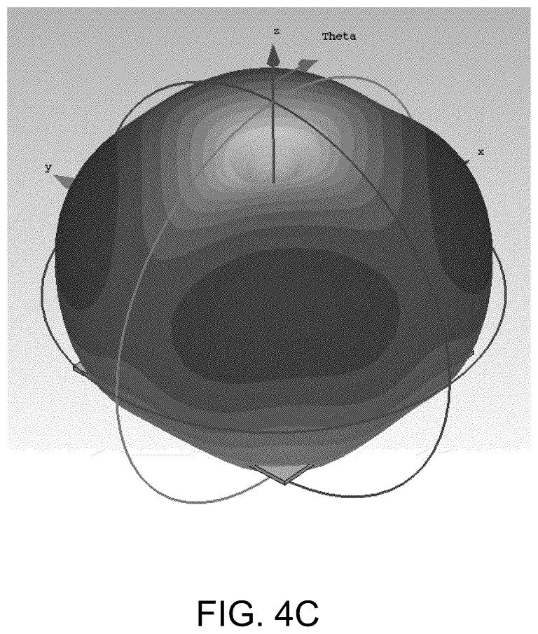

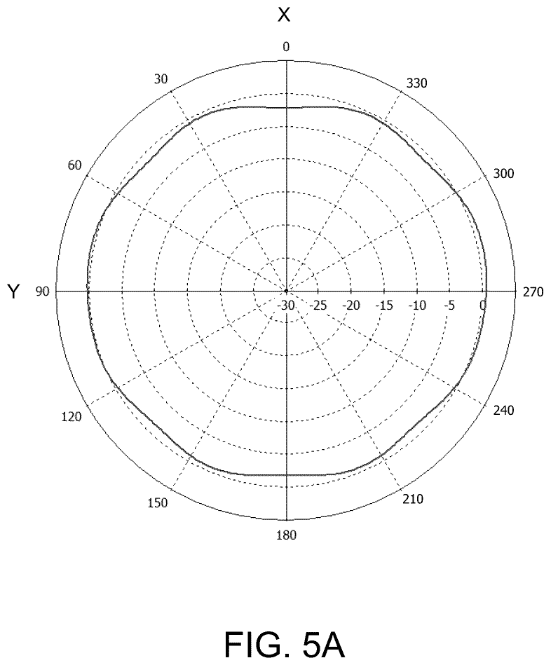

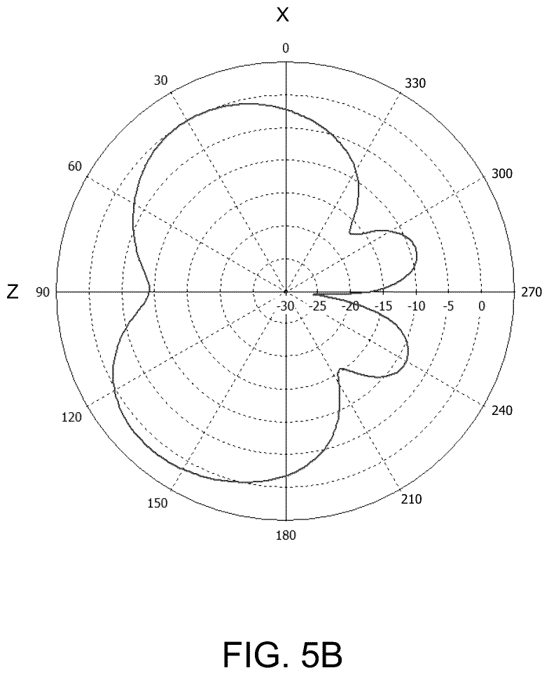

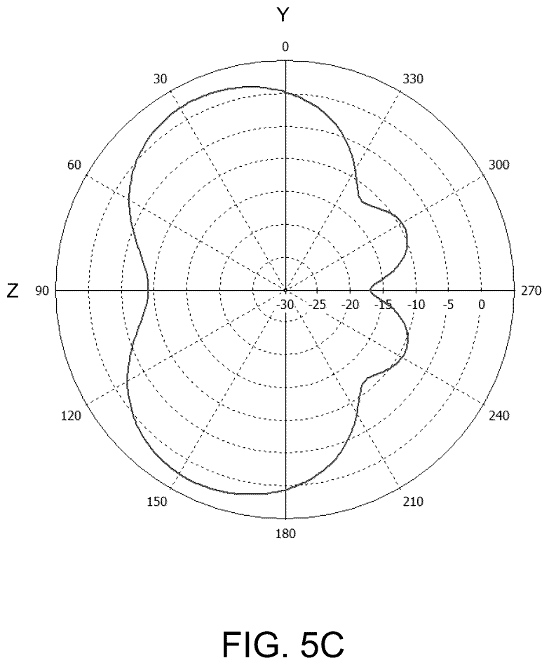

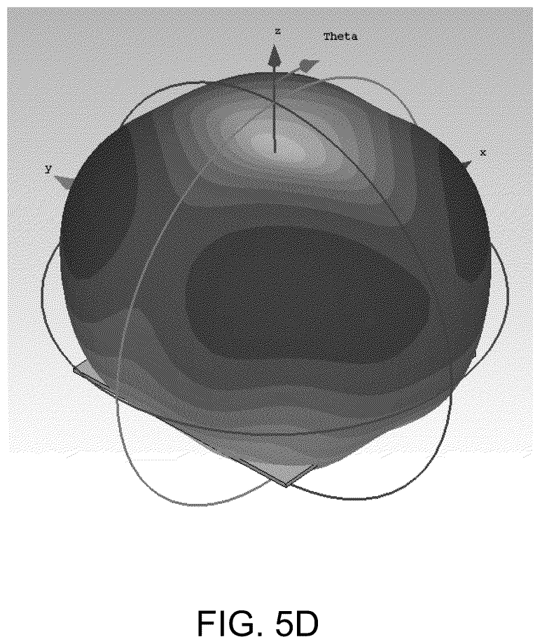

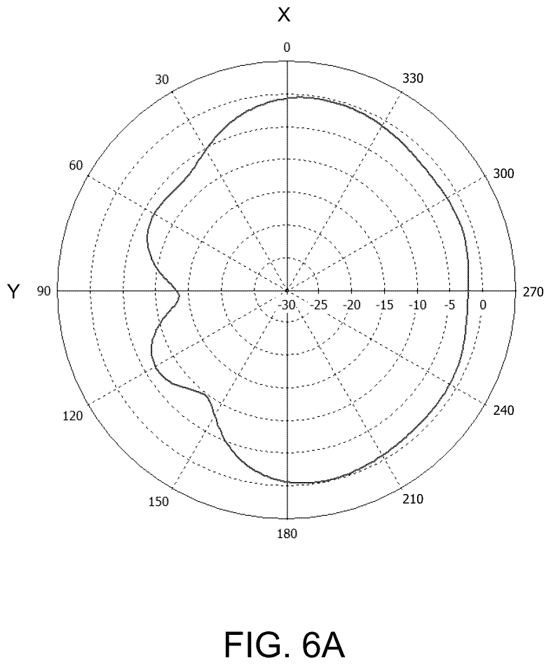

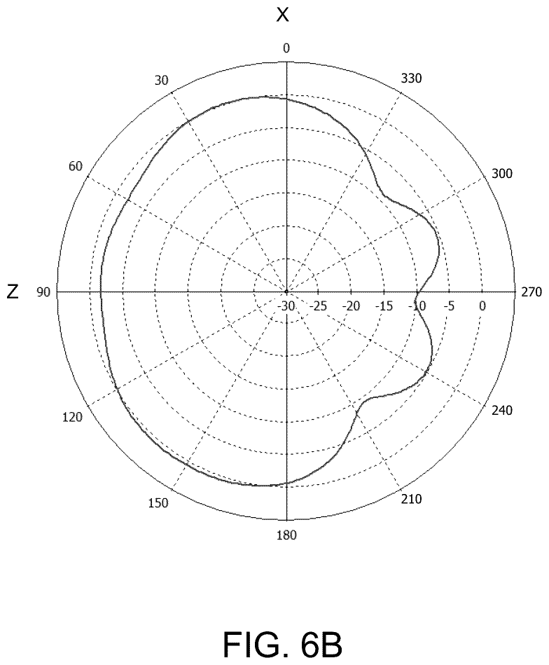

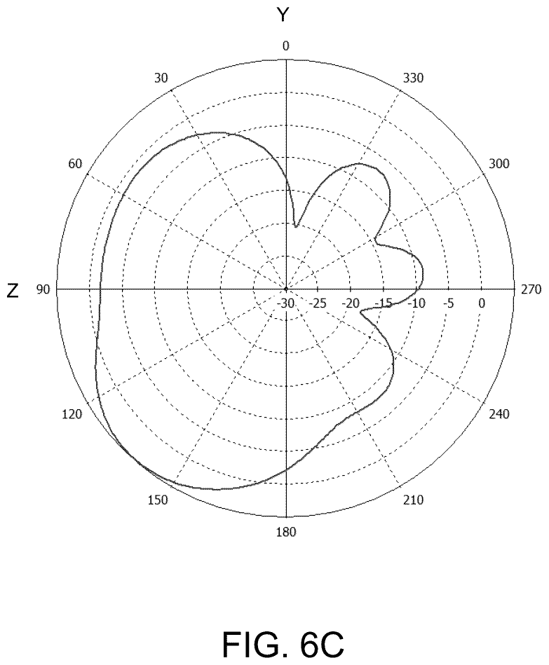

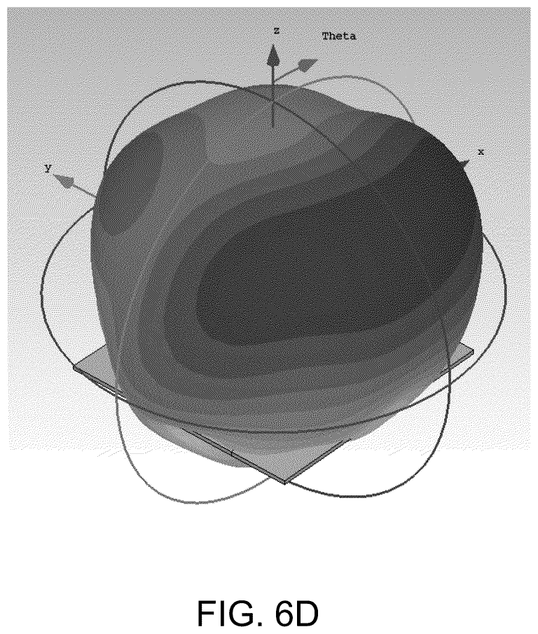

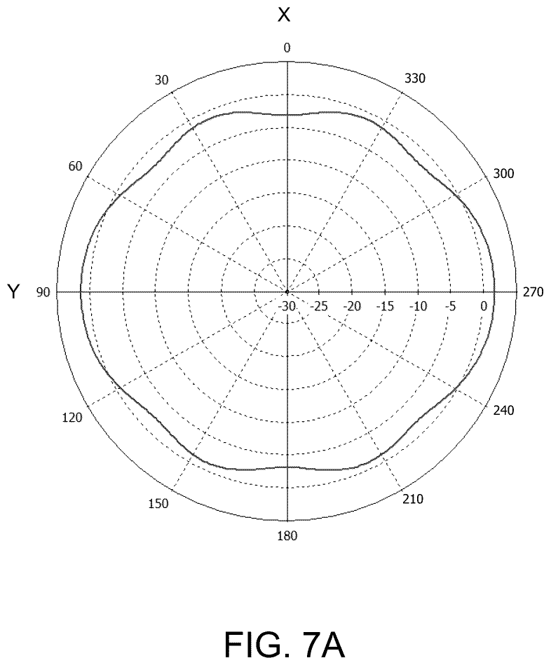

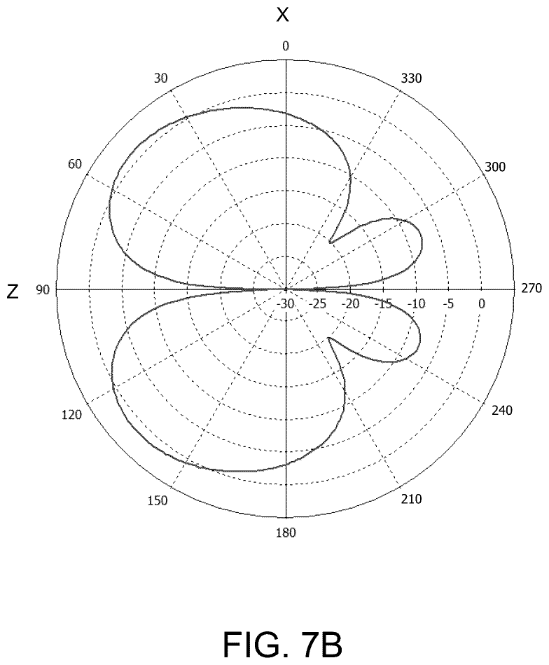

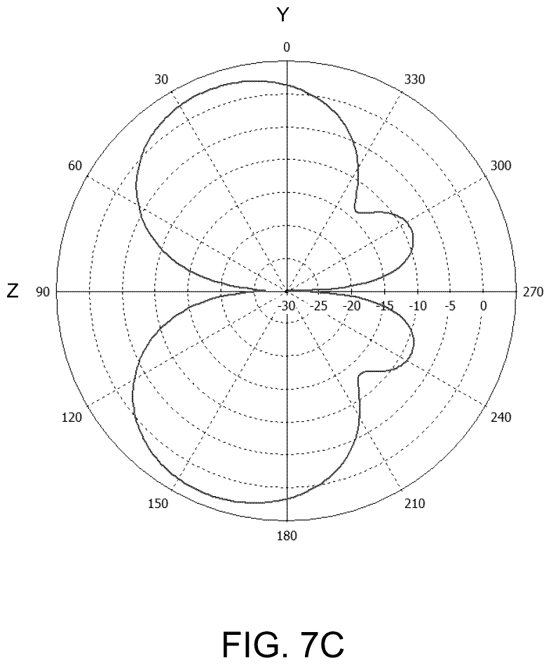

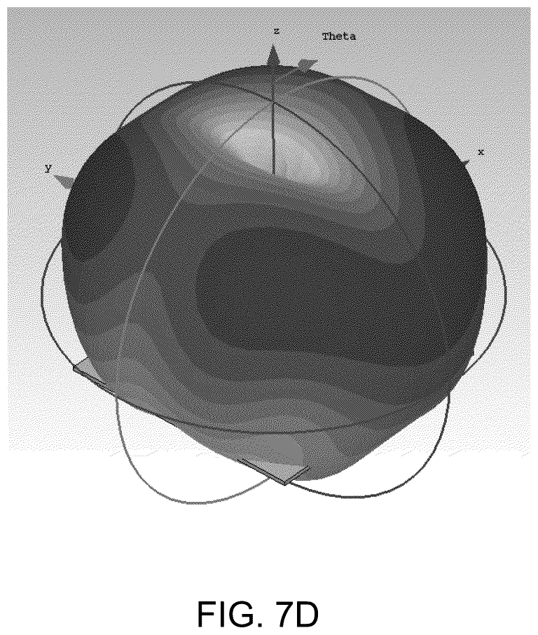

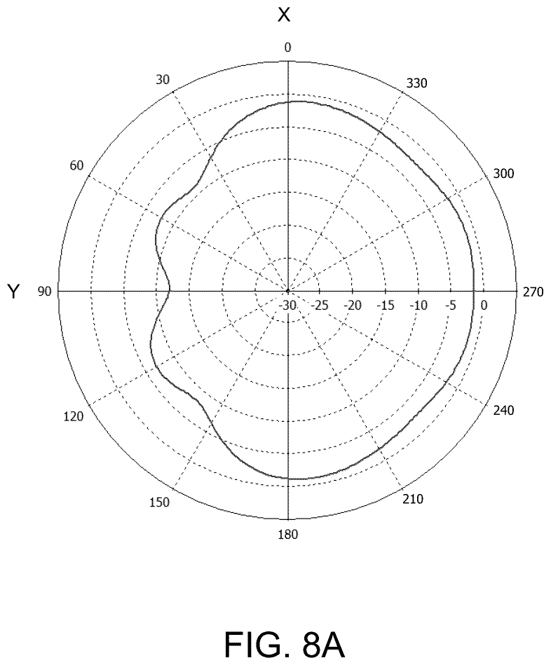

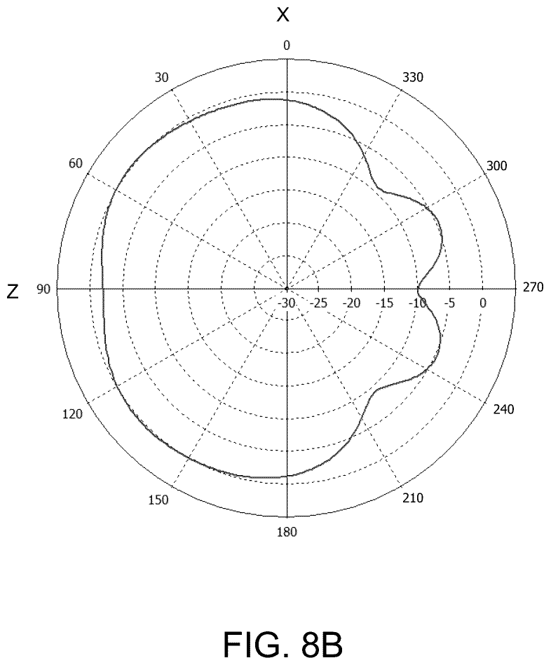

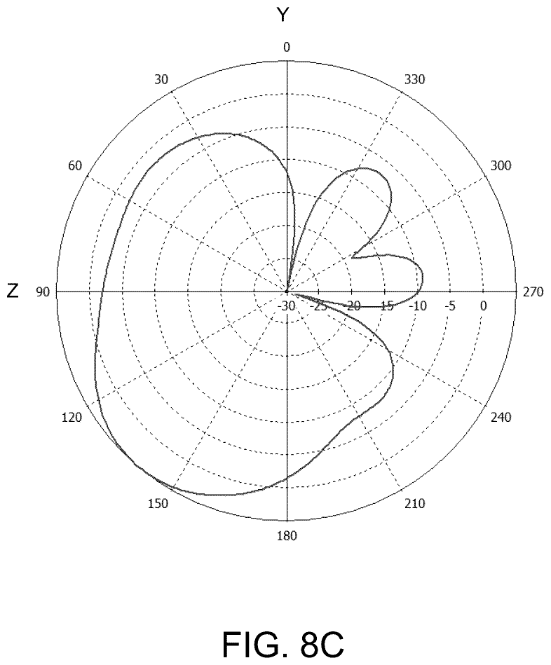

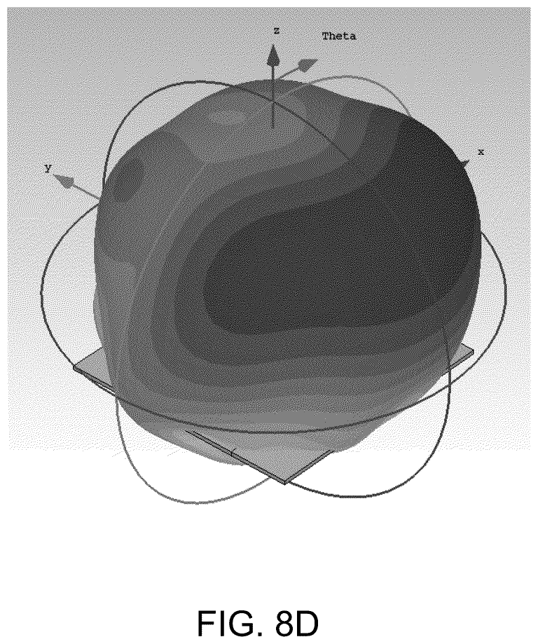

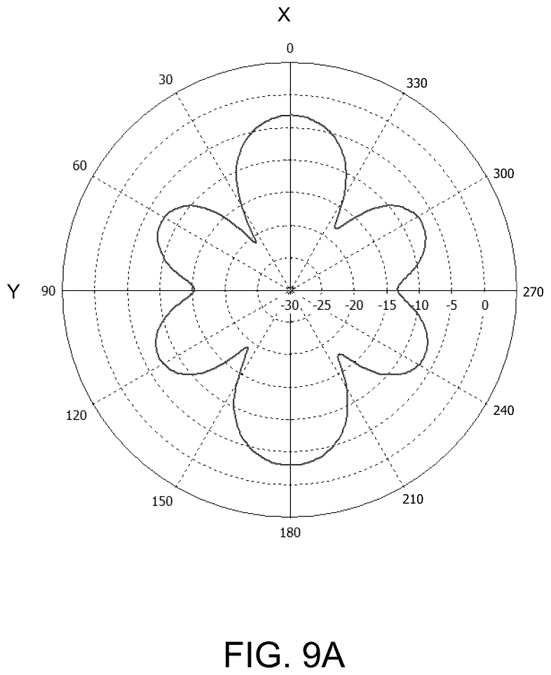

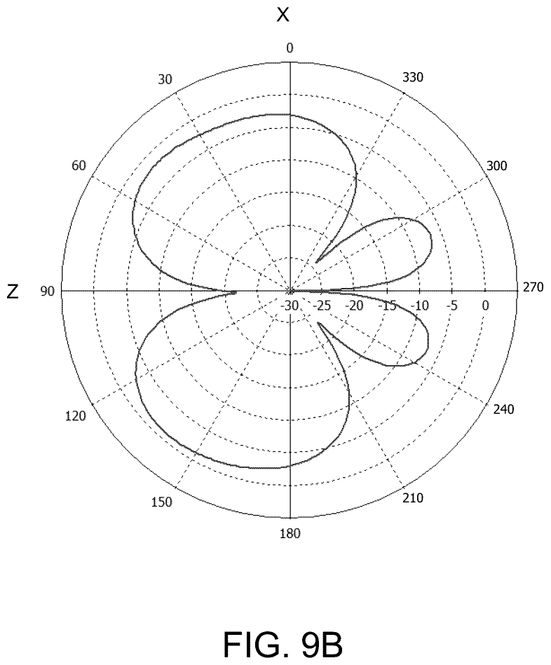

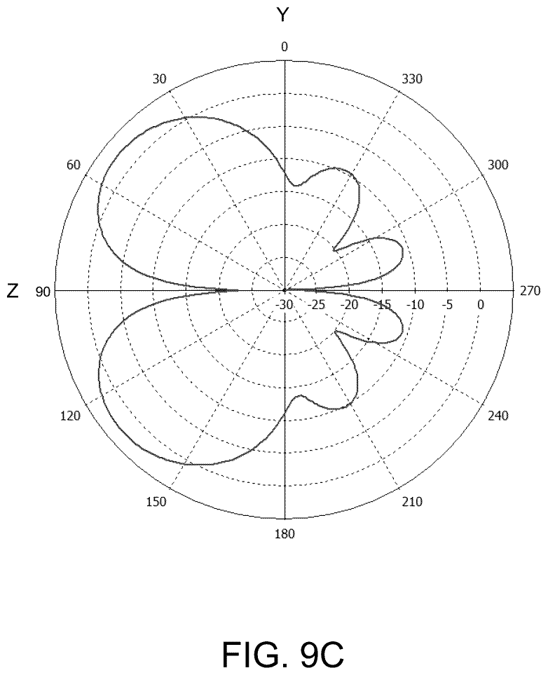

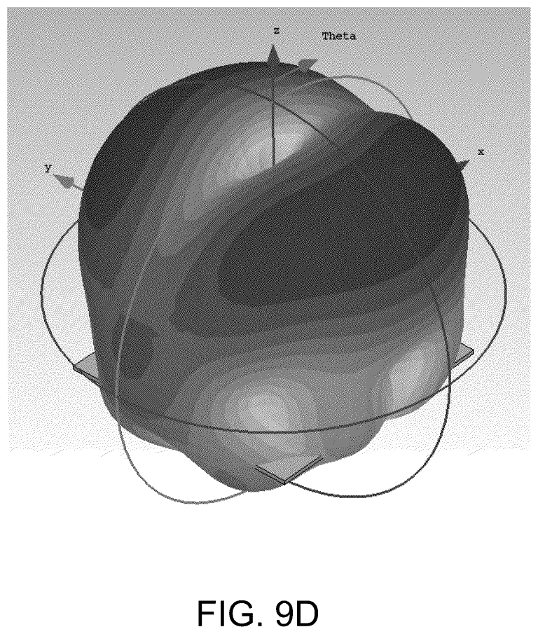

The following description will focus on the case where the radiation pattern in the horizontal and vertical directions of the radiation signals is controlled and adjusted through the reflectors 30A, 30B, 30C and 30D. Referring to FIG. 4A to FIG. 9D, FIG. 4A, FIG. 5A, FIG. 6A, FIG. 7A, FIG. 8A and FIG. 9A are schematic views of radiation patterns in the horizontal plane direction; FIG. 4B, FIG. 5B, FIG. 6B, FIG. 7B, FIG. 8B and FIG. 9B are schematic views of the radiation patterns in the X-axis vertical plane direction; FIG. 5C, FIG. 6C, FIG. 7C, FIG. 8C and FIG. 9C are schematic views of the radiation patterns in the Y-axis vertical plane direction; FIG. 4C, FIG. 5D, FIG. 6D, FIG. 7D, FIG. 8D and FIG. 9D are 3D color schematic views of the radiation patterns. These drawings illustrate following adjustment modes of the reflectors and the adjusted radiation patterns included in the present invention, but the present invention is not limited thereto.

As shown in FIG. 4A, in some embodiments of the present invention, when the switch elements 40A, 40B, 40C and 40D of the antenna structure 1 are all turned off, the reflectors 30A, 30B, 30C and 30D will not affect signals radiated by the radiator 20, so the horizontal radiation pattern of the radiator 20 is a nearly omnidirectional radiation pattern. As shown in FIG. 4B, when viewed from the X axis in the vertical direction of the antenna structure 1 (from the side of the reflectors 30A and 30C), the ground plane 10 is located in the direction of 270 degrees, which will affect the radiation signals to some extent, so the vertical radiation pattern of the radiator 20 will be reflected towards the direction from 0 degree to 60 degrees and the direction from 120 degrees to 180 degrees, while the radiation signals in the direction from 180 degrees to 360 degrees will be weakened. In addition, when none of the reflectors 30A, 30B, 30C and 30D is turned on, the radiation pattern in the direction of Y axis (at the side of the reflectors 30B and 30D) is equivalent to that of the X axis, and thus the radiation pattern in the direction of Y axis is not shown.

When viewed from the 3D color schematic view of the radiation pattern as shown in FIG. 4C, the horizontal radiation pattern of the radiator 20 is a nearly omnidirectional radiation pattern, and signals in the Z axis direction is slightly weaker. Therefore, in this mode, the radiator 20 may be adapted to desktop wireless routers or other wireless apparatuses to spread radiation signals horizontally around, so that electronic apparatuses around the wireless router within a space can all receive high-quality radiation signals.

As shown in FIG. 5A, in some embodiments of the present invention, when only one switch element of the antenna structure 1 is turned on, for example, when the switch element 40A of the antenna structure 1 is turned on, the reflector 30A located in the 0 degree direction and connected with the switch element 40A will be grounded, thereby generating a reflection effect on the radiation signals emitted by the radiator 20. Therefore, when viewed from the horizontal direction of FIG. 5A, some radiation signals of the radiator 20 will be reflected by the reflector 30A towards the opposite direction (for example, when the reflector 30A is located in the 0 degree direction, some radiation signals of the radiator 20 will be reflected by the reflector 30A towards the direction of about 180 degrees). Since the reflector 30A forms an angle IA, that is, the reflector 30A is arranged on the ground plane 10 at an inclined angle, some radiation signals of the radiator 20 are also reflected by the reflector 30A towards the directions of about 90 degrees and 270 degrees.

Meanwhile, the vertical radiation pattern of the radiator 20 is also changed according to the arrangement of the reflector 30A. In detail, as shown in FIG. 5B, when viewed from the X axis in the vertical direction of the antenna structure 1, the turned-on reflector 30A is located in the 0 degree direction of FIG. 5B, so the radiation signals will be reflected towards the direction from 30 degrees to 60 degrees and the direction from 120 degrees to 150 degrees relative to the vertical direction of the Z axis by the angle IA of the reflector 30A, and the radiation signals at 150 degrees may be slightly stronger than that in the direction of 30 degrees. As shown in FIG. 5C, when viewed from the Y axis in the vertical direction of the antenna structure 1, the radiation signals will be uniformly reflected towards the direction from 0 degree to 60 degrees and the direction from 120 degrees to 180 degrees relative to the vertical direction of the Z axis by the angle IA of the reflector 30A.

When viewed from the 3D color schematic view of the radiation pattern as shown in FIG. 5D, the radiation pattern is concentrated on the right side of the X axis and Y axis in the horizontal direction, which corresponds to that the radiation signals of FIG. 5A is reflected towards the direction from 180 degrees to 270 degrees. Moreover, some radiation signals are reflected towards the Z axis, which corresponds to that the radiation signals of FIG. 5B is reflected towards the directions from 0 degree to 60 degrees and from 120 degrees to 180 degrees relative to the Z axis, and the radiation signals of FIG. 5C is reflected towards the directions from 0 degree to 60 degrees and from 120 degrees to 180 degrees relative to the Z axis. Therefore, in this mode, the radiator 20 is adapted to desktop wireless routers or other wireless apparatuses to spread radiation signals around, so that electronic apparatuses within the space can receive high-quality radiation signals.

As shown in FIG. 6A, in some embodiments of the present invention, when a plurality of switch elements of the antenna structure 1 are turned on, for example, when the switch elements 40A and 40B of the antenna structure 1 are turned on, the reflector 30A located in the 0 degree direction and connected with the switch element 40A and the reflector 30B located in the 90 degree direction and connected with the switch element 40B will be grounded, so that the radiation signals are reflected by the reflectors 30A and 30B towards the opposite direction. Therefore, some radiation signals of the radiator 20 will be reflected by the reflectors 30A and 30B towards the direction from 180 degrees to 270 degrees, and at this time, some radiation signals will also be reflected towards the direction from 0 degree to 330 degrees.

As shown in FIG. 6B, when viewed from the X axis in the vertical direction of the antenna structure 1, the turned-on reflector 30A is located in the 0 degree direction of FIG. 6B, so the radiation signals will be reflected towards the direction from 90 degrees to 150 degrees relative to the vertical direction of the Z axis by the angle IA of the reflector 30A, and thus the radiation signals at 150 degrees will be slightly stronger than that at 30 degrees. As shown in FIG. 6C, when viewed from Y axis in the vertical direction of the antenna structure 1, the turned-on reflector 30B is located in the 0-degree direction of FIG. 6C, so the radiation signals will be reflected towards the direction from 120 degrees to 150 degrees relative to the vertical direction of the Z axis by the angle IA of the reflector 30B.

When viewed from the 3D color schematic view of the radiation pattern as shown in FIG. 6D, the radiation pattern is concentrated on the right side of the X axis and Y axis in the horizontal direction, which corresponds to that the radiation signals of FIG. 6A are reflected towards the direction from 180 degrees to 270 degrees. Moreover, some radiation signals are reflected towards the Z axis, which corresponds to that the radiation signals of FIG. 6B are reflected towards the direction from 90 degrees to 150 degrees relative to the Z axis, and the radiation signals of FIG. 6C are reflected towards the direction from 120 degrees to 150 degrees relative to the Z axis. Therefore, in this mode, the radiator 20 may be adapted to wall-mounted wireless routers or other wireless apparatuses installed on a wall, so as to transmit radiation signals from the wall to one side in the vertical normal direction of the wall, so that electronic apparatuses within the space can receive high-quality radiation signals.

As shown in FIG. 7A, in some embodiments of the present invention, when a plurality of switch elements of the antenna structure 1 are turned on, for example, when the switch elements 40A and 40C of the antenna structure 1 are turned on, the reflector 30A located in the 0 degree direction and connected with the switch element 40A and the reflector 30C located in the 180 degree direction and connected with the switch element 40C will be grounded, so that the radiation signals will be reflected by the reflectors 30A and 30C towards the opposite direction. Therefore, some radiation signals of the radiator 20 will be reflected by the reflectors 30A and 30C towards the direction from 0 degree and 180 degrees, and the radiation signals will be slightly reflected towards two sides of 90 degrees and 270 degrees in the horizontal direction due to the influence of the angles IA of the reflectors 30A and 30C.

As shown in FIG. 7B, when viewed from the X axis in the vertical direction of the antenna structure 1, the turned-on reflector 30A is located in the 0 degree direction and the reflector 30C is located in the 180 degree direction of FIG. 7B, so the radiation signals will be uniformly reflected towards the directions from 30 degrees to 60 degrees and from 120 degrees to 150 degrees relative to the vertical direction of the Z axis by the angle IA of the reflectors 30A and 30C. As shown in FIG. 7C, when viewed from the Y axis in the vertical direction of the antenna structure 1, the radiation signals will be reflected towards the direction from 0 degree to 60 degrees and the direction from 120 degrees to 180 degrees relative to the vertical direction of the Z axis by the angle IA of the reflectors 30A and 30C.

When viewed from the 3D color schematic view of the radiation pattern as shown in FIG. 7D, the radiation pattern is concentrated on the left and right sides of the X axis and Y axis in the horizontal direction, which corresponds to that the radiation signals of FIG. 7A are slightly reflected towards two sides of 90 degrees and 270 degrees in the horizontal direction. Moreover, some radiation signals are reflected towards the Z axis, which corresponds to that the radiation signals of FIG. 7B are uniformly reflected towards the direction from 30 degrees to 60 degrees and the direction from 120 degrees to 150 degrees relative to the Z axis, and radiation signals of FIG. 7C are uniformly reflected towards the direction from 0 degree to 60 degrees and the direction from 120 degrees to 180 degrees relative to the Z axis. Therefore, in this mode, the radiator 20 may be adapted to ceiling-mounted wireless routers or other wireless apparatuses installed on a ceiling to transmit radiation signals from the ceiling to the ground, so that electronic apparatuses on the ground can receive high-quality radiation signals.

As shown in FIG. 8A, in some embodiments of the present invention, when a plurality of switch elements of the antenna structure 1 are turned on, for example, when switch elements 40A, 40B and 40C of the antenna structure 1 are turned on, the reflector 30A located in the 0 degree direction and connected with the switch element 40A, the reflector 30B located in the 90 degree direction and connected with the switch element 40B, and the reflector 30C located in the 180 degree direction and connected with the switch element 40C will be grounded, so that the radiation signals will be reflected by the reflectors 30A, 30B and 30C towards the opposite direction. Therefore, some radiation signals of the radiator will be reflected by the reflectors 30A, 30B and 30C towards the directions of 0 degree, 180 degrees and 270 degrees.

As shown in FIG. 8B, when viewed from the X axis in the vertical direction of the antenna structure 1, the turned-on reflector 30A is located in the 0 degree direction and the reflector 30C is located in the 180 degree direction of FIG. 8B, so the radiation signals will be uniformly reflected towards the direction from 30 degrees to 90 degrees and the direction from 90 degrees to 150 degrees relative to the vertical direction of the Z axis by the angle IA of the reflectors 30A and 30C. As shown in FIG. 8C, when viewed from the Y axis in the vertical direction of the antenna structure 1, the turned-on reflector 30B is located in the 0 degree direction of FIG. 8C, so the radiation signals will be reflected towards the direction from 120 degrees to 180 degrees relative to the vertical direction of the Z axis by the angle IA of the reflector 30B.

When viewed from the 3D color schematic view of the radiation pattern as shown in FIG. 8D, the radiation pattern is concentrated on the right side of the X axis and Y axis in the horizontal direction, which corresponds to that the radiation signals of FIG. 8A are reflected towards the direction from 240 degrees to 300 degrees. Moreover, some radiation signals are reflected towards the Z axis, which corresponds to that the radiation signals of FIG. 8B are reflected towards the direction from 0 degree to 60 degrees and the direction from 120 degrees to 180 degrees relative to the Z axis, and the radiation signals of FIG. 8C are reflected towards the direction from 0 degree to 60 degrees and from 120 degrees to 180 degrees relative to the Z axis. Therefore, in this mode, the radiator 20 may be adapted to ceiling-mounted wireless routers or other wireless apparatuses installed on a ceiling to transmit radiation signals from the ceiling to the ground, so that electronic apparatuses on the ground can receive high-quality radiation signals.

As shown in FIG. 9A, in some embodiments of the present invention, when a plurality of switch elements of the antenna structure 1 are turned on, for example, when switches elements 40A, 40B, 40C and 40D of the antenna structure 1 are turned on, the reflector 30A located in the 0 degree direction and connected with the switch element 40A, the reflector 30B located in the 90 degree direction and connected with the switch element 40B, the reflector 30C located in the 180 degree direction and connected with the switch element 40C, and the reflector 30D located in the 270 degrees direction and connected with the switch element 40D will be grounded, so that the radiation signals will be reflected by the reflectors 30A, 30B, 30C and 30D towards the opposite direction. Therefore, some radiation signals of the radiator 20 will be reflected by the reflectors 30A, 30B, 30C and 30D (that is, reflected towards four directions of 0 degree, 90 degrees, 180 degrees and 270 degrees at the same time). However, according to the interference principle of signals (for example, destructive interference and constructive interference) and because of the influence of the angle IA on the radiation signals, the radiation signals reflected by the reflectors 30A, 30B, 30C and 30D will interact with each other, thereby exhibiting a radiation pattern with a petal-like shape.

As shown in FIG. 9B, when viewed from the X axis in the vertical direction of the antenna structure 1, the turned-on reflector 30A is located in the 0 degree direction and the reflector 30C is located in the 180 degree direction of FIG. 9B, so the radiation signals will be uniformly reflected towards the direction from 30 degrees to 90 degrees and the direction from 90 degrees to 150 degrees relative to the vertical direction of the Z axis by the angle IA of the reflectors 30A and 30C. As shown in FIG. 9C, when viewed from the Y axis in the vertical direction of the antenna structure 1, the turned-on reflector 30B is located in the 0 degree direction of FIG. 9C and the reflector 30D is located in the 180 degree direction of FIG. 9C, so the radiation signals will be reflected towards the direction from 30 degrees to 60 degrees and the direction from 120 degrees to 150 degrees relative to the vertical direction of the Z-axis by the angle IA of the reflector 30B.

When viewed from the 3D color schematic view of the radiation pattern as shown in FIG. 9D, the four reflectors 30A, 30B, 30C and 30D are turned on at the same time, so the radiation signals can be reflected intensively in the vertical direction of the Z axis, which corresponds to that the radiation signals in FIG. 9B are reflected in the direction from 30 degrees to 90 degrees and the direction from 90 degrees to 150 degrees relative to the Z axis, and the radiation signals in FIG. 9C are reflected towards the direction from 30 degrees to 60 degrees and the direction from 120 degrees to 150 degrees relative to the vertical direction of the Z axis. In this mode, the radiation signals in the Z axis direction will achieve the best effect by concentrating the radiation signals in the Z axis direction for reflection. Therefore, in this mode, the radiator 20 may be adapted to ceiling-mounted wireless routers or other wireless apparatuses installed on a ceiling to transmit radiation signals from the ceiling to the ground, so that electronic apparatuses on the ground can receive high-quality radiation signals.

To sum up, with the switch elements 40A, 40B, 40C and 40D of the antenna structure 1 of the present invention, the reflectors 30A, 30B, 30C and 30D can respectively be controlled effectively to achieve sixteen modes, so that the radiation signals can be reflected in different horizontal directions, and the radiation signals can be reflected to the vertical direction of the Z axis by the angle IA of the reflectors 30A, 30B, 30C and 30D. In addition, the description of the use environment of the wireless routers with respect to FIG. 4C, FIG. 5D, FIG. 6D, FIG. 7D, FIG. 8D and FIG. 9D is not limited to the above-mentioned embodiments, and various radiation patterns can be adjusted in response to different use environments according to the needs of users. In other words, the antenna structure 1 of the present invention can provide good radiation signal coverage in various use environments.

In some embodiments of the present invention, the antenna structure 1 further includes a wave director 50 (not shown), wherein the wave director 50 is arranged and suspended above the radiator 20 to change a vertical radiation pattern of the antenna structure 1. Specifically, the wave director 50 may be made of metal (such as copper, silver, gold, etc.). Unlike the reflector 30, the wave director 50 is not connected with the ground plane 10. Therefore, when radiation signals emitted by the radiator 20 pass through the wave director 50, the wave director 50 will increase the amplitude of the radiation signals and extend the radiation signals so as to enhance the signal strength in the vertical direction. In addition, a bracket or a supporting base made of insulating material IM (such as ceramics, glass, wood, polyethylene and polystyrene, etc.) may be arranged between the wave director 50 and the radiator 20, so that the wave director 50 can be suspended over the radiator 20.

In some embodiments of the present invention, the wave director 50 includes a plurality of wave director structures (such as, but not limited to, a first herringbone wave director 50A and a second herringbone wave director 50B). Moreover, according to the electromagnetic theory described above, the preferred length of the first herringbone wave director 50A is 0.45λ and the preferred distance between the first herringbone wave director 50A and the radiator 20 is 0.125λ, while the preferred length of the second herringbone wave director 50B is 0.4λ and the preferred distance between the second herringbone wave director 50B and the first herringbone wave director 50A is 0.2λ. The wave director 50 can achieve the best wave guiding effect for the radiation signals in combination with such wavelength segment ratios. Furthermore, the first herringbone wave director 50A is arranged and suspended above the radiator 20, and the second herringbone wave director 50B is arranged and suspended above the first herringbone wave director 50A. The intensity of radiation signals can be further increased with the arrangement of two or more wave director structures.

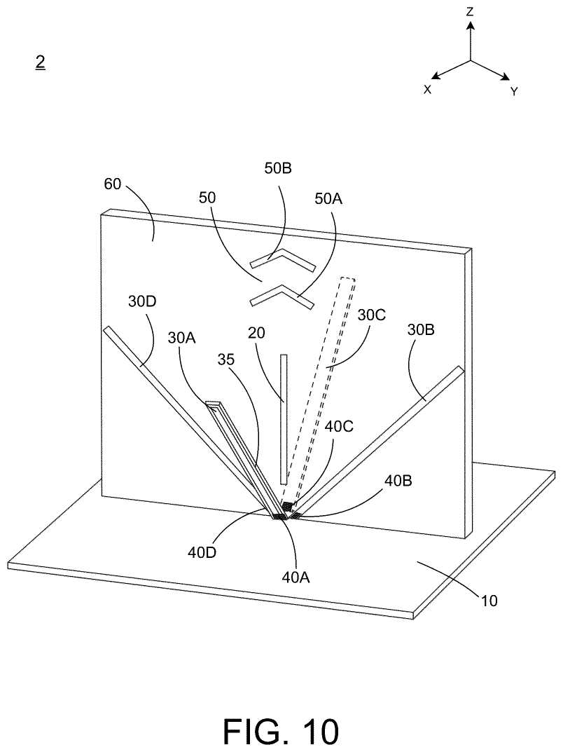

As shown in FIG. 10, in some embodiments of the present invention, the antenna structure 2 further includes a radiator substrate 60 vertically arranged on the ground plane 10. Unlike the antenna structure 1, the antenna structure 2 of the present invention may employ a PCB-mounted antenna so as to arrange the radiator 20 on the radiator substrate 60. In this way, the radiator 20 may be directly suspended above the ground plane 10, while some reflectors (such as, but not limited to, the reflector 30B and the reflector 30D) among the reflectors, some switch elements (such as, but not limited to, the switch element 40B and the switch element 40D) among the switch elements and one or more wave directors 50 are all arranged on the radiator substrate 60, and thus more usage space and material cost can be saved.

In some embodiments of the present invention, the antenna structure 2 further includes one or more reflector substrates 35 (not shown), wherein the reflector substrates 35 are symmetrically and equidistantly arranged around the periphery of the radiator 20 with the radiator 20 as a center, and multiple reflectors (such as, but not limited to, the reflectors 30A and 30C) and multiple switch elements are respectively arranged on the reflector substrates 35. The reflectors are connected with the ground plane 10 through the switches, and the reflective substrates 35 are fixed on the ground plane 10 through a mechanical structure. Further, in some embodiments of the present invention, the radiator 20 may be arranged in a suspended manner, and the radiation substrate 60 is fixed on the ground plane 10 through a mechanical structure.

In some embodiments of the present invention, the number of reflectors and switch elements may be adjusted according to various wireless routers of different dimensions and specifications. For example, the number of reflectors and switch elements may be eight or more, and preferably the reflectors and switch elements are provided in even numbers, so that the reflectors can be symmetrically and equidistantly arranged around the periphery of the radiator with the radiator as a center. The control effect of radiation signals is improved by increasing the number of reflectors, thereby achieving the purpose of adjusting the directivity of the radiation signals.

The above embodiments are only examples for illustrating the present invention, and are not intended to limit the scope claimed in the present invention. Any other embodiments produced by modifying, changing, adjusting and integrating the above-mentioned embodiments shall all be included in the scope claimed in the present invention as long as they are not difficult for those of ordinary skill in the art to contemplate. The scope claimed in the present invention shall be governed by the claims.

What is claimed is:

1. An antenna structure, comprising:
a ground plane,
a radiator, being arranged and suspended above the ground plane;
one or more reflectors, forming an angle with the radiator relative to the ground plane and being arranged at a distance around the periphery of the radiator; and
one or more switch elements, being respectively arranged between the one or more reflectors and the ground plane to control the connection between the one or more reflectors and the ground plane,
wherein the radiator is a dipole antenna radiator.

2. The antenna structure according to claim 1, wherein the reflectors are symmetrically and equidistantly arranged around the periphery of the radiator with the radiator as a center.

3. The antenna structure according to claim 2, wherein the antenna structure comprises a total of four reflectors and the four reflectors are respectively arranged at positions of 0 degree, 90 degrees, 180 degrees and 270 degrees relative to the radiator.

4. The antenna structure according to claim 1, wherein the length of the radiator ranges from 0.45λ to 0.55λ, and the length of the one or more reflectors ranges from 0.5λ to 0.62λ.

5. The antenna structure according to claim 4, wherein the length of the radiator is 0.5λ, and the length of the one or more reflectors is 0.56λ.

6. The antenna structure according to claim 1, further comprising one or more wave directors, wherein the one or more wave directors are arranged and suspended above the radiator.

7. The antenna structure according to claim 6, wherein the wave directors comprise a first herringbone wave director with a length of 0.45λ and arranged and suspended at a distance of 0.125λ above the radiator, and a second herringbone wave director with a length of 0.4λ and arranged and suspended at a distance of 0.2λ above the first herringbone wave director.

8. The antenna structure according to claim 1, wherein the angle is a 45-degree angle.

9. The antenna structure according to claim 1, further comprising a radiator substrate vertically arranged on the ground plane, and the radiator is arranged on the radiator substrate.

10. The antenna structure according to claim 6, further comprising a radiator substrate vertically arranged on the ground plane, and the radiator is arranged on the radiator substrate.

11. The antenna structure according to claim 10, wherein the one or more wave directors are arranged on the radiator substrate.

12. The antenna structure according to claim 10, wherein some of the reflectors and some of the switch elements are arranged on the radiator substrate.

13. The antenna structure according to claim 1, further comprising one or more reflector substrates, wherein the reflector substrates are symmetrically and equidistantly arranged around the periphery of the radiator with the radiator as a center, and the reflectors are respectively arranged on the reflector substrates.

14. The antenna structure according to claim 10, further comprising one or more reflector substrates, wherein the reflector substrates are symmetrically and equidistantly arranged around the periphery of the radiator with the radiator as a center, and the reflectors are respectively arranged on the reflector substrates.
